(19) United States
(12) Patent Application Publication
(10) Pub. No.: US 2021/0123196 A1
(43) Pub. Date: Apr. 29, 2021

(54) PROTECTIVE ARRANGEMENT

(71) Applicant: REBLOC GmbH, Gars am Kamp (AT)

(72) Inventor: Mathias REDLBERGER, Gars am Kamp (AT)

(21) Appl. No.: 17/046,591

(22) PCT Filed: Apr. 8, 2019
(86) PCT No.: PCT/EP2019/058818

§ 371 Date: Nov. 11, 2020

(30) Foreign Application Priority Data
Apr. 12, 2018 (AT) A 101/2018

(51) Int. Cl. E01F 15/14; E01F 13/02; E01F 13/12

(52) U.S. Cl. CPC E01F 15/14; E01F 13/12; E01F 13/02

(57) ABSTRACT

Disclosed is a protective arrangement having elements which essentially consist of concrete and are connected to one another via detachable couplings. The elements of the protective arrangement are arranged in the form of a closed frame.

The invention relates to a protective arrangement with elements that essentially consist of concrete and are connected to one another via detachable couplings.

The safeguarding of squares, pedestrian zones, buildings, or other sensitive public spots against unauthorized intrusion by motor vehicles is gaining in importance. In the case of the solutions that exist for this purpose, a distinction can be made between stationary or permanent design measures and mobile or temporary measures.

Temporary measures play an important role mainly in the case of the safeguarding of event locations, such as Christmas markets or festivals, and therefore should be deployable in a flexible manner and can be assembled and disassembled quickly and easily. In this case, there are both technical and economic as well as temporal advantages when such systems can be arranged freely and do not have to be connected to the ground.

Since numerous incidents have shown that when intrusion is done into such zones with the intention of harming people and/or facilities, very often heavy motor vehicles (e.g., tractor-trailers) are used, systems that are intended to effectively prevent such intrusions must also be designed for a correspondingly high impact energy.

The systems currently deployed include, for example, motor vehicles, steel containers, and concrete blocks, but also concrete elements designed for use in motor vehicle barrier systems on streets in order to block squares or streets. The protective effect of such obstacles in the case of an impact from a heavy motor vehicle is, however, barely appreciable and frequently inadequate. In addition, the use of many of these obstacles is especially expensive, and/or, in particular when motor vehicles are used as obstacles, very expensive.

The object of the invention is therefore to provide a protective arrangement that can be used not only in a flexible manner but also can be assembled and disassembled easily and quickly and that is suitable to withstand the impact from a heavy motor vehicle.

This object is achieved according to the invention with a protective arrangement that has the features of claim 1.

Preferred and advantageous embodiments of the invention are the subject matter of the subclaims.

According to the invention, it is provided that the elements of the protective arrangement are arranged in the form of a closed frame. Because of the closed geometric shape of the protective arrangement, the latter is able to absorb in an effective way the forces that are produced with an impact from a motor vehicle, since because of the frame form overall, a large mass is available to disperse the impact energy; however, the frame form can be easily assembled and disassembled. It is advantageous that a motor vehicle in the case of an impact against a protective arrangement confront essentially the entire mass of the protective arrangement, since the shape of the closed frame prevents a “breakthrough” through the protective arrangement.

In a preferred embodiment, the protective arrangement has a polygonal, closed basic form, which in particular is triangular. With this frame form, the forces that are produced in the case of an impact from a motor vehicle can be absorbed essentially in the form of tensile and compressive forces, in particular when a corner faces the impact side.

As an alternative, the basic form of the protective arrangement can also have more than three corners and can be made, for example, quadrangular or hexagonal.

The protective arrangement is, as mentioned, preferably oriented so that one corner of the preferably triangular basic form points in any direction from which an impact from a motor vehicle is most likely to be expected or so that the preferably triangular basic form points away with one corner from the surface or arrangement that is to be protected.

In particular, within the framework of the invention, an embodiment is preferred in which at least two of the elements of the protective arrangement are elongated elements with a face and a longitudinal axis.

Preferably, but not necessarily, the corners of the basic form in each case have two elongated elements, which are connected to one another on front sides either directly or immediately or via a corner element. In the second case, the elongated elements can be connected via in each case a face to a common connecting surface of the corner element or to various connecting surfaces of the corner element. The longitudinal axes of the elongated elements comprise an angle that is simultaneously considered to be a corner angle of the preferably triangular basic form.

Embodiments in which each of the angles is between 30° and 120°, especially preferably between 45° and 90°, in particular essentially 60°, are preferred. In the case of a triangular basic form, the angles yield a sum of 180°, as with any triangle.

In a preferred, but not required, embodiment, the basic form of the protective arrangement has a triangular shape with two angles of essentially equal value, so that the basic form of the protective arrangement forms an equilateral triangle. In an especially preferred embodiment, the basic form of the protective arrangement has a triangular shape with three angles of essentially equal value of approximately 60°, so that the basic form of the protective arrangement forms an equilateral triangle.

To connect the elongated elements below one another and optionally to corner elements, detachable couplings are provided within the framework of the invention, wherein especially preferably couplings as described in WO 2010/057232 A are used. However, any other detachable coupling can also be used.

Within the framework of the invention, a barrier is also provided that has multiple protective arrangements according to the invention, wherein the protective arrangements are arranged in at least one row or in groups. Because of such a barrier, access roads, streets, or open sides of areas that are to be protected can be blocked against the intrusion by motor vehicles, wherein in the case of advantageous embodiments, pedestrians can walk past the barriers unhindered.

Additional details, features, and advantages of the invention follow from the description below with reference to the attached drawings, in which preferred embodiments are depicted. Here:

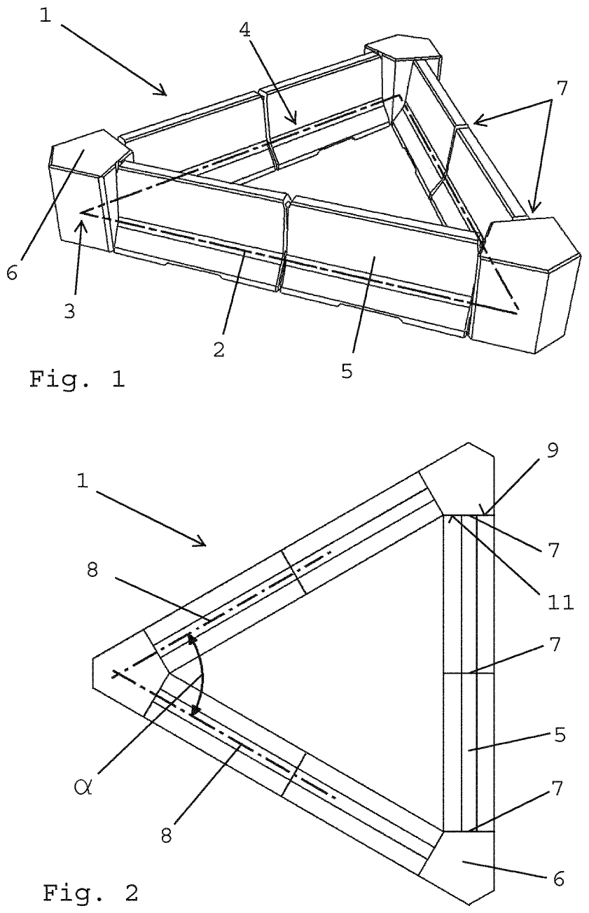

FIG. 1 shows an isometric view of a protective arrangement according to the invention,

FIG. 2 shows a top view of the protective arrangement of FIG. 1 according to the invention,

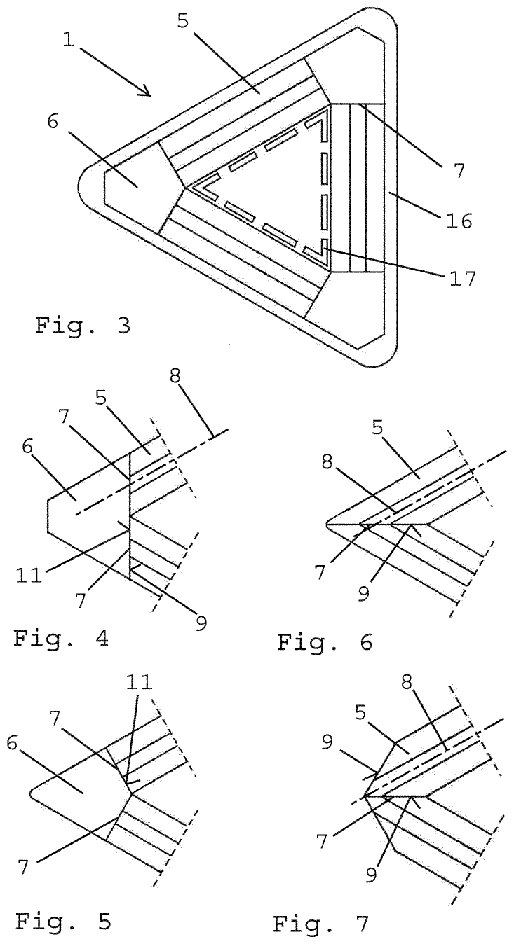

FIG. 3 shows a top view of a protective arrangement according to the invention according to another embodiment,

FIG. 4 to FIG. 7 in each case show a top view of one corner of a protective arrangement according to the invention according to other embodiments,

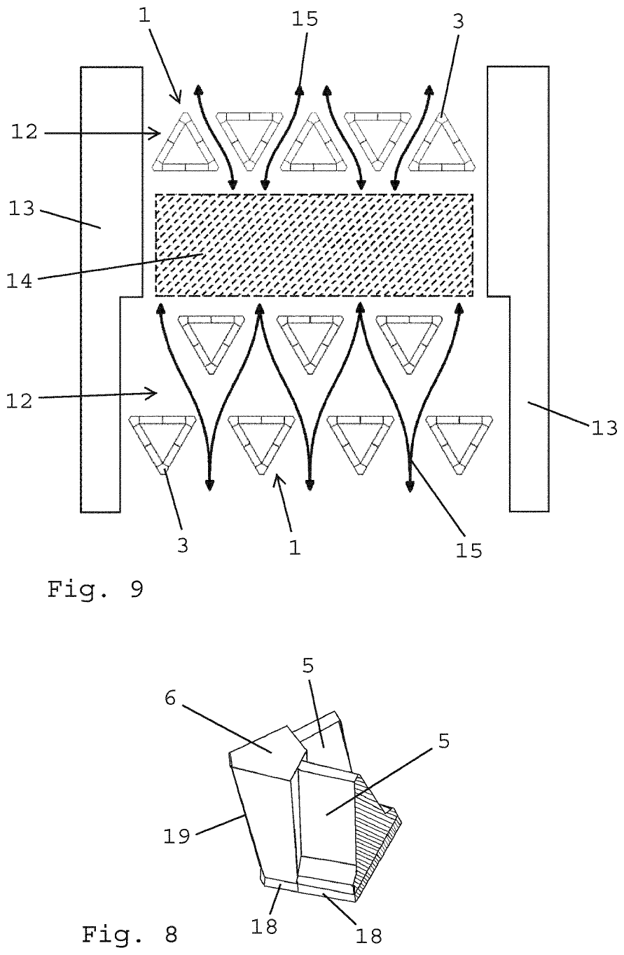

FIG. 8 shows an isometric view of one corner of a protective arrangement according to the invention according to another embodiment,

FIG. 9 shows a schematic arrangement of two embodiments of a barrier according to the invention in a top view, and

FIG. 10 to FIG. 14 show schematic top views of embodiments of other barriers according to the invention.

FIGS. 1 and 2 show a protective arrangement 1 according to the invention in isometric view or in top view, wherein the basic form 2 of the protective arrangement 1 in the depicted embodiment has the shape of an equilateral triangle with three corners 3 and three sides 4. The elements 5, 6 of the protective arrangement 1 are arranged in the form of a closed frame, in which an open area remains in the center that is, however, also filled with suitable, preferably rigid and/or heavy material or can be used in another way.

The protective arrangement 1 has elongated elements 5 and corner elements 6, which are detachably connected to one another via couplings 7 that are arranged between the elements 5, 6.

The couplings 7 are depicted only symbolically and preferably made as depicted and described in WO 2010/057232 A.

The elongated elements 5 can preferably be concrete elements that are known from the state of the art and are designed for use in motor vehicle barrier systems on streets, with a wide base area and a narrow central area, e.g., in the form of a double-sided “New Jersey profile.” On each end, they have a face 9 that is orthogonal to the longitudinal axis 8 of the elongated element 5.

The elongated elements 5 can, however, also have any other shape, wherein the length of the elongated elements 5 does not necessarily have to be greater than its width and/or height. Within the framework of the invention, elongated elements 5 that have a different cross-sectional profile, e.g., elongated elements 5 that are designed simply as boxes or as horizontal prisms, for example with a triangular cross-section, are also conceivable in the case of all embodiments of the invention.

The corner elements 6 of the embodiment of FIGS. 1 and 2 have the shape of a straight prism with an irregular pentagonal base and a vertical axis that is oriented orthogonally thereto, wherein two lateral surfaces of the corner element are designed as connecting surfaces 11. Since the frame form of the protective arrangement in the depicted embodiment has the basic form 2 of an equilateral triangle, the connecting surfaces 11 are oriented to one another at an inside angle α of 120°.

Each of the corners 3 of the basic form 2 is formed by two of the elongated elements 5 with in each case one corner element 6, wherein the elongated elements 5 are connected to one another via one of the corner elements 6. The longitudinal axes 8 of the elongated elements 5 of a corner 3 comprise an angle α (60° in the embodiments of FIGS. 1 and 2), which can simultaneously also be defined as a corner angle of the basic form 2 of the protective arrangement 1.

In the depicted embodiment, the protective arrangement 1 comprises six elongated elements 5 and three corner elements 6. In this case, each of the elongated elements 5 is connected at one of the faces 8 via a detachable coupling 7 to one of the connecting surfaces 11 of one of the corner elements 6 and at the other face 8 via another detachable coupling 7 to a different face 8 of another elongated element 5.

In the embodiment depicted in FIG. 3, which embodiment is similar to the embodiment of FIGS. 1 and 2, the protective arrangement 1 comprises three corner elements 6 and only three elongated elements 5. Each elongated element 5 thus forms one of the corners 3 of the basic form 2 at both ends together with a corner element 6 and one end of another elongated element 5.

FIGS. 4 to 7 show other possible embodiments of the protective arrangement 1 according to the invention, in which the corners 3 of the basic form 2 are formed in a different way or using differently-shaped elements 5, 6.

In FIG. 4, the base of the corner element has a quadrangular shape, in particular that of an isosceles trapezoid. As a result, the corner element 6 has only a single connecting surface 11. Both elongated elements 5 are connected at one of their faces 9 via in each case one detachable coupling 7 to the connecting surface 11, wherein the longitudinal axis 8 of each of the elongated elements 5 is oriented not orthogonally but rather obliquely to the respective face 9.

FIG. 5 shows an embodiment with a corner element 6, which has an edge on the side that points away from the connecting surfaces 11, so that the corner element 6 is essentially a prism with a deltoid-shaped base.

FIG. 6 shows an embodiment of a corner 3 of the protective arrangement 1 according to the invention, which arrangement has no corner elements 6. The corner 3 of the basic form 2 is formed only by the elongated elements 5, which are connected to one another directly at the faces 9 that are obliquely inclined toward the longitudinal axes 8 via detachable couplings 7. It is advantageous but not required when with this embodiment, all corners 3 of the basic form 2 of the protective arrangement 1 are formed in the same way without corner elements 6.

FIG. 7 shows another embodiment of the protective arrangement 2 according to the invention, in which no corner element 6 is used at the corners 3 of the basic form 2 of the protective arrangement 1. In this embodiment, the elongated elements 5 have two faces 9 that are inclined equally to the longitudinal axis 8, essentially forming a tip, which faces are preferably both equipped with coupling elements, so that the elongated elements 5 can be installed in any position when the protective arrangement 1 is being constructed—unlike in the case of the embodiment of FIG. 6.

When all elongated elements 5 of the protective arrangement 1 and both ends of the elongated elements 5 have this structural form, intermediate elements can be provided at the sides 4 of the basic form 2 between elongated elements 5, which intermediate elements have suitable coupling surfaces, at which they are connected to the faces 9 of the adjacent, elongated elements 5 via detachable couplings 7.

The other end, not shown in FIG. 7, can also, however, have an orientation that is orthogonal to the longitudinal axis.

The structural configuration of the corners 3 of the basic form 2 of the protective arrangement 1 is not limited to the embodiments that are shown in FIGS. 4 to 7. Thus, within the framework of the invention, for example, an embodiment is also conceivable in which the corner element 6 has only a single connecting surface 11, as shown in FIG. 4, and an edge that is directed away from the connecting surface 11, as shown in FIG. 5. Other forms, which are produced from other combinations of the embodiments that are shown in FIGS. 4 to 7, are also possible.

Within the framework of the invention, corner elements 6 that have, e.g., the shape of a prism with triangular, quadrangular, hexagonal, or polygonal bases, as well as rectangular or square bases, or the shape of another suitable polyhedron, are also possible, wherein even bent or circular sections of the base can be present.

As depicted in FIG. 8, at least one of the corner elements 6 can be formed in the case of all possible embodiments, so that a surface or edge of the corner element 6, which is facing away from the elongated elements 5 and is directed outward, has an overhang 19. This means that an upper edge or an upper corner point of the surface or edge that points outward extends further out than a lower edge or a lower corner point of the surface or edge that points outward. Embodiments of the protective arrangement 1 according to the invention without corner elements 6 are also conceivable, however, in which ends of the elongated elements 5, which collide in the corners 3 of the basic form 2 of the protective arrangement 1, are formed in such a way that a surface or edge that points outward is formed with overhang 19. Because of the design measure of an overhang 19, there is more effective protection against a motor vehicle that drives into the corner 3 of the protective arrangement 1 rising upward upon impact and being thrown over the protective arrangement 1.

Also, the longitudinal elements can be completely or partially undercut. Preferably, for this purpose, at least one of the elongated elements has at least one lateral surface that runs parallel to its longitudinal axis, which lateral surface is inclined obliquely downward or has an overhang, as was described in principle regarding the corner element.

In the case of all embodiments of the protective arrangement 1 according to the invention in which the sides 4 of the basic form 2 have more than one elongated element 5, intermediate elements can be provided between the elongated elements 5, wherein the elongated elements 5 are connected at faces 9 via detachable couplings 7 to coupling surfaces of the intermediate elements.

In the case of the invention, means can be provided with which the friction between the elements 5, 6 of the protective arrangement 1 and the base on which they are arranged can be increased. In one embodiment that is especially preferred within the framework of the invention, the elements 5, 6 of the protective arrangement 1 can be arranged on a support mat 16, as is depicted in FIG. 3. Such a support mat 16 can simultaneously also serve as a template in order to provide, during construction of the protective arrangement 1, indications as to the position at which and the angle at which each element 5, 6 is to be arranged. For this purpose, the support mat 16 can have a shape or identification 17, such as, for example, colored markings and/or ridges and/or recesses. The identification 17 corresponds to the basic form 2 or the form of the closed frame in which the elements 5, 6 are arranged, or limits the basic form 2 or the form of the closed frame at least in sections outward and/or inward. In addition or as an alternative, as depicted in FIG. 8, an anti-skid layer 18 can be applied to the bottom surfaces of the elements 5, 6.

FIG. 9 shows two embodiments of a barrier 12 according to the invention in a schematic top view, wherein in each case, an access road, for example between two buildings 13, which runs to an area 14 or facility that is to be blocked or protected, is blocked against motor vehicles by the barriers 12; however, paths 15 are left open for pedestrians. In each case, the barriers 12 have one or two rows of multiple protective arrangements 1 according to the invention that are arranged beside one another, wherein the protective arrangements 1 of these embodiments in each case have a basic form 2 in the shape of an equilateral triangle.

The embodiment of the barrier 12 depicted below in FIG. 9 has a first row of protective arrangements 1 arranged beside one another, and another row of protective arrangements 1 arranged beside one another, wherein one corner 3 of each arrangement points away from the area 14 that is to be protected. The other row of protective arrangements 1 is upstream from the row adjacent to the area 14 that is to be protected—with respect to the area 14 that is to be protected—and is arranged offset from the first row. The protective arrangements 1 of the two rows all have essentially the same orientation in this embodiment.

In the case of the embodiment of the barrier 12 that is depicted above in FIG. 9, the barrier 12 has a row of protective arrangements 1 that are arranged beside one another and that alternately in each case point away with one corner 3 from the area 14 that is to be protected and toward the area 14 that is to be protected.

FIGS. 10 to 14 show other embodiments of barriers 12 according to the invention, in which multiple protective arrangements 1 are connected to one another.

The protective arrangements 1 of the barriers 12 in each case have three elongated elements 5 and three corner elements 6, wherein the elongated elements 5 in the schematic display format selected for FIGS. 10 to 13 are indicated by dashes and the corner elements 6 are indicated by dots. When the corners 3 are designed, for example, as depicted in FIG. 7, the barrier 12 can also be constructed without corner elements 6.

In the case of such an embodiment, the inner corner elements 6 must have the shape of a regular hexagon. The corner elements at the corners of the barrier 12 can be made as depicted in FIGS. 1 to 5. The corner elements 6 at the longitudinal sides of the barrier 12 can be, for example, regular hexagons, but preferably pentagons.

In the case of the barriers 12 of FIGS. 10 to 14, the elements 5, 6 of each individual protective arrangement 1 are arranged in a basic form 2 that has the shape of an essentially equilateral triangle. Other shapes of the basic form 2 are, however, also conceivable.

Basic forms 2 that are adjacent to one another along a side 4 have a common elongated element 5 and two common corner elements 6 or share the latter. Basic forms 2 that are adjacent to one another only at one corner 3 have only one common corner element 6 or share the latter.

The barrier 12 depicted in FIG. 10 consists of protective arrangements 1, which are arranged in three superimposed rows that are connected to one another, wherein the barrier 12 itself has the shape of an equilateral triangle. Depending on the point of view, the barrier 12 comprises six protective arrangements 1 that are oriented in the same way and that in each case are adjacent to one another only at their corners 3, or nine protective arrangements 1 that are oriented differently and that are adjacent to one another along their sides 4.

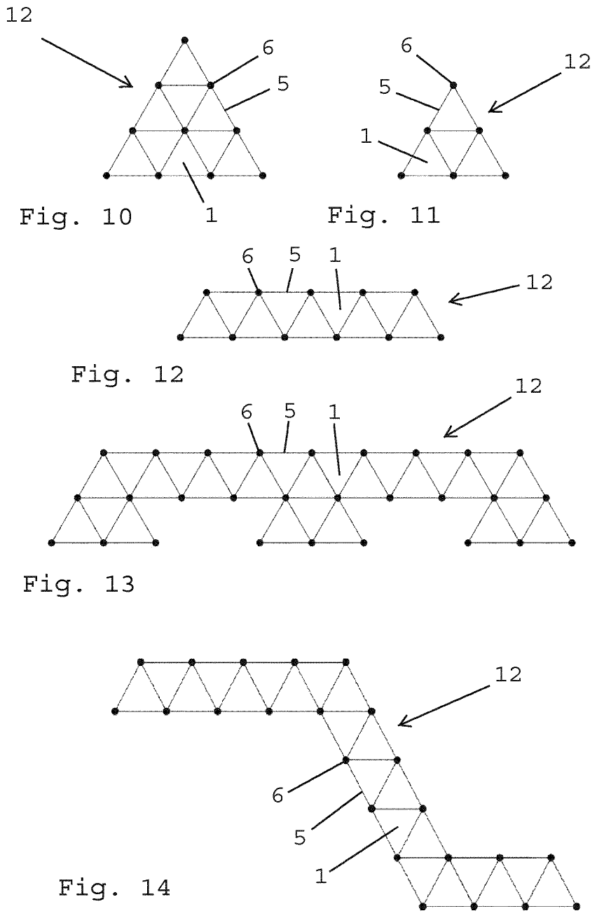

The barrier 12 depicted in FIG. 11 is constructed like the barrier 12 depicted in FIG. 10, but with two, instead of three, rows of protective arrangements 1. Depending on the point of view, the barrier 12 of FIG. 11 comprises three or four protective arrangements 1.

FIG. 12 shows a barrier 12, in which all protective arrangements 1 are arranged in a single row, and comprises nine protective arrangements 1, which are adjacent to one another along their sides 4.

The barrier 12 depicted in FIG. 13 is essentially a combination of the barriers 12 from FIGS. 11 and 12.

FIG. 14 shows a barrier 12 according to the invention, which is constructed in such a way that it follows an essentially Z-shaped contour. Because of such a contour, but also other shapes, it is possible to protect differently-shaped areas 14 and/or facilities from multiple sides or directions with a continuous barrier.

Within the framework of the invention, all possible combinations of the embodiments depicted in FIGS. 10 to 14 are conceivable, just like embodiments of barriers 12, in which the protective arrangements 1 have more than three elongated elements 5 and/or in which the basic forms 2 do not have the shape of an equilateral triangle, but rather, for example, the shape of a rectangle or a hexagon.

In all depicted embodiments, the elongated elements 5 and the corner elements 6 of an individual protective arrangement 1 have the same shape. Embodiments in which at least one individual protective arrangement 1 has differently-shaped elements 5, 6 or embodiments of barriers 12 that have protective arrangements 12 with different elements 5, 6 are also conceivable, however.

1. Protective arrangement (1) with elements (5, 6), which consist essentially of concrete and are connected to one another via detachable couplings (7), wherein the elements (5, 6) of the protective arrangement (1) are arranged in the form of a closed frame.

2. The protective arrangement according to claim 1, wherein the protective arrangement (1) has a polygonal basic form (2).

3. The protective arrangement according to claim 2, wherein at least two of the elements (5, 6) of the protective arrangement (1) are elongated elements (5) with a face (9) and a longitudinal axis (8).

4. The protective arrangement according to claim 3, wherein corners (3) of the basic form (2) in each case have two of the elongated elements (5) whose longitudinal axes (8) comprise an angle (α).

5. The protective arrangement according to claim 4, wherein each of the angles (α) of the basic form (2) of a protective arrangement (1) is between 30° and 120°.

6. The protective arrangement according to claim 4, wherein at least two of the angles (α) are of equal value, and the basic form (2) has the shape of an essentially equilateral triangle.

7. The protective arrangement according to claim 4, wherein all angles (α) are essentially of equal value, and the basic form (2) has the shape of an essentially equilateral triangle.

8. The protective arrangement according to claim 4, wherein two elongated elements (5) at one corner (3) are connected directly to one another at faces (9) via at least one of the detachable couplings (7).

9. The protective arrangement according to claim 4, wherein two elongated elements (5) of one corner (3) are connected to one another via a corner element (6).

10. The protective arrangement according to claim 9, wherein the corner element (6) has at least one connecting surface (11) and wherein both elongated elements (5) are connected at a face (9) via in each case at least one of the detachable couplings (7) to the connecting surface (11).

11. The protective arrangement according to claim 9, wherein the corner element (6) has at least two connecting surfaces (11) and wherein both elongated elements (5) are connected at a face (9) via in each case at least one of the detachable couplings (7) to in each case one of the connecting surfaces (11).

12. The protective arrangement according to claim 9, wherein the corner element (6) has essentially the shape of a prism with a vertical axis.

13. The protective arrangement according to claim 12, wherein the corner element (6) is a prism with a triangular, quadrangular, or pentagonal base.

14. The protective arrangement according to claim 9, wherein the corner element (6) has at least one area or edge with an overhang (19), where said area or edge faces away from the elongated elements (5).

15. The protective arrangement according to claim 3, wherein each side (4) of the basic form (2) is formed by at least one elongated element (1).

16. The protective arrangement according to claim 15, wherein at least one of the sides (4) of the basic form (2) is formed by at least two elongated elements (5), wherein the two elongated elements (5) are connected to one another via at least one detachable coupling, and the longitudinal axes (8) of the two elongated elements (5) essentially align.

17. The protective arrangement according to claim 14, wherein at least one of the sides (4) of the basic form (2) is formed by at least two elongated elements (5), which elements are connected to one another via at least one intermediate element, wherein the intermediate element has at least two coupling surfaces, and wherein both elongated elements (5) are connected at a face (9) via at least one detachable coupling (7) to one of the coupling surfaces.

18. The protective arrangement according to claim 3, wherein at least one of the elongated elements (5) has at least one tilted lateral surface, running parallel to the longitudinal axis (8), with an overhang.

19. The protective arrangement according to claim 2, wherein the protective arrangement (1) has a support mat (16) on which the elements (5, 6) are arranged.

20. The protective arrangement according to claim 19, wherein the support mat (16) has a shape or identification (17) that corresponds to the basic form (2).

21. The protective arrangement according to claim 19, wherein the support mat (16) consists at least partially of anti-skid material.

22. The protective arrangement according to claim 1, wherein at least one of the elements (5, 6) has a bottom surface with an anti-skid surface (18).

23. The protective arrangement according to claim 22, wherein the anti-skid surface (18) is formed by ridges and/or recesses on the bottom surface.

24. The protective arrangement according to claim 21, wherein the anti-skid surface (18) is formed by an anti-skid layer or coating on the bottom surface.

25. Barrier (12), comprising multiple protective arrangements (1), wherein the protective arrangements (1) of the barrier (12) are made according to claim 1.

26. The barrier according to claim 25, wherein at least two of the protective arrangements (1) are connected to one another in such a way that at least one of the elements (5, 6) of one of the protective arrangements (1) is also an element (5, 6) of the associated protective arrangement (1).

27. The barrier according to claim 26, wherein the protective arrangements (1) have elongated elements (5) and corner elements (6) and wherein at least one of the elongated elements (5) and at least two of the corner elements (6) of one of the protective arrangements (1) are also elements (5, 6) of the associated protective arrangement (1).

28. The barrier according to claim 25, wherein protective arrangements (1) that are individual and/or connected to one another are arranged beside one another in a row.

29. The barrier according to claim 28, wherein the protective arrangements (1) of at least one row in each case point in the same direction with a corner (3) of the basic form (2).

30. The barrier according to claim 29, wherein the protective arrangements (1) of at least one row alternatively in each case point in different directions with a corner (3) of the basic form (2).
